(19) United States
(12) Patent Application Publication
(10) Pub. No.: US 2019/0129203 A1
(43) Pub. Date: May 2, 2019

(54) HOLOGRAPHIC EYEGLASS LENS

(71) Applicant: Keli ZHENG, Changsha (CN)

(72) Inventor: Keli ZHENG, Changsha (CN)

(21) Appl. No.: 15/922,440

(22) Filed: Mar. 15, 2018

(30) Foreign Application Priority Data
Oct. 28, 2017 (CN) 201711035686.8

(51) Int. Cl. G02C 7/06; G02B 5/32

(52) U.S. Cl. CPC G02C 7/066; G02B 5/32

(57) ABSTRACT

The present invention discloses a holographic eyeglass lens. The holographic eyeglass lens comprises a lens body whose central attention optical zone is a free-focus lens, and is provided with a butterfly-shaped holographic zoom ring in a direction from an optical center to the edge of the lens. The holographic eyeglass lens of the present invention brings distinct images and rich gradation in visual sense and has good effects of filtering ultraviolet rays, and other light waves of stray light and glare light harmful to sights of the eyes.

### CROSS REFERENCE TO RELATED APPLICATIONS

This application claims priority to the Chinese Patent Application CN201711035686.8, entitled “HOLOGRAPHIC EYEGLASS LENS”, filed on Oct. 8, 2017; the above-identified application is hereby incorporated by reference in its entirety as if fully set forth herein.

### BACKGROUND

### 1. Technical Field

The invention relates to the field of eyeglass accessories, in particular, to a holographic eyeglass lens.

### 2. Description of Related Art

Eyeglasses configured by embedding lenses in a frame are worn in front of the eyes, to improve eyesight, protect the eyes or serve for decorative purposes. Eyeglasses can be used to correct a variety of eyesight problems, including myopia, hyperopia, astigmatism, presbyopia, strabismus or the like. Eyeglasses are composed of leases and frames and divided into myopic eyeglasses, hyperopic eyeglasses, presbyopic eyeglasses and astigmatism eyeglasses. There are also special eyeglasses for 3D stereoscopic or virtual reality images. Other kinds of eyeglasses include goggles, sunglasses, swimming goggles, etc., to provide a variety of protections for the eyes. For modern eyeglasses, a nose pad is usually arranged between lenses, and cushions are arranged in positions of the left arm and the right arm resting on the ears. People who love to be beautiful or who are not used to wearing eyeglasses can choose to correct their eyesight with contact lenses. The existing eyeglasses lens has only one focus point to result in diagonal aberration, sharpness drop and unclear gradation after wearing, thereby leading to poor sensory images and poor effects of filtering light waves of stray light and glare light harmful to sights of the eyes.

### SUMMARY

Aiming at the shortcomings above in existing technology, the invention is to provide holographic eyeglass lens in order to solve the problems proposed in the background.

For achieving the objective above, the invention provide the following technical solution.

1. A holographic eyeglass lens comprises a lens body (1) whose central attention optical zone is a free-focus lens (5), and is provided with a butterfly-shaped holographic zoom ring in a direction from an optical center to the edge of the lens, wherein the radius of the butterfly-shaped holographic zoom ring is not smaller than 4.5 mm. An optical path guide zone (2) is arranged at the periphery of the lens (1); the free-focus lens (5) serves to freely focus within a range of 16 mm from an optical center. A zone of moving 4.5 mm from the optical center towards the outer edge of the lens is defined as a high-beam focus zone (6). A zone of moving from 4.5 mm to 11.5 mm is defined as a mid-beam focus zone (3). Then, a zone of moving from 11.5 mm to 16 mm is defined as a low-beam focus zone (7). A zone from 16 mm to 38 mm, i.e., the outermost edge of the lens, is defined as the optical path guide zone (2).

2. The holographic eyeglass lens according to claim 1, wherein the butterfly-shaped holographic zoom ring is arranged at the high-beam focus zone (6) in a direction from the optical center to the edge of the lens, wherein the radius of the butterfly-shaped holographic zoom ring is not smaller than 4.5 mm.

3. The holographic optical resin eyeglass lens according to claim 1, wherein the degree progressively decreases by 0.01 every a movement of 0.5 mm from the optical center (4) to the outer edge of the lens.

Compared with the prior art, the present invention has the beneficial effects: compared to the existing lens that has only one focus point, the improved lens realizes free focusing within a range of 16 mm from the optical center in the free-focus lens, and the degree progressively increases or decreases by 0.01 every a movement of 0.5 mm. The high-beam focus zone, the low-beam focus zone and the mid-beam focus zone are arranged within an attention optical zone from the optical center of the free-focus lens to 16 mm. The holographic eyeglass lens of the present invention brings distinct images and rich gradation in visual sense after wearing and has good effects of filtering ultraviolet rays, and other light waves of stray light and glare light harmful to sights of the eyes.

### BRIEF DESCRIPTION OF THE DRAWINGS

FIG. 1 is a front-view structural schematic drawing of the invention.

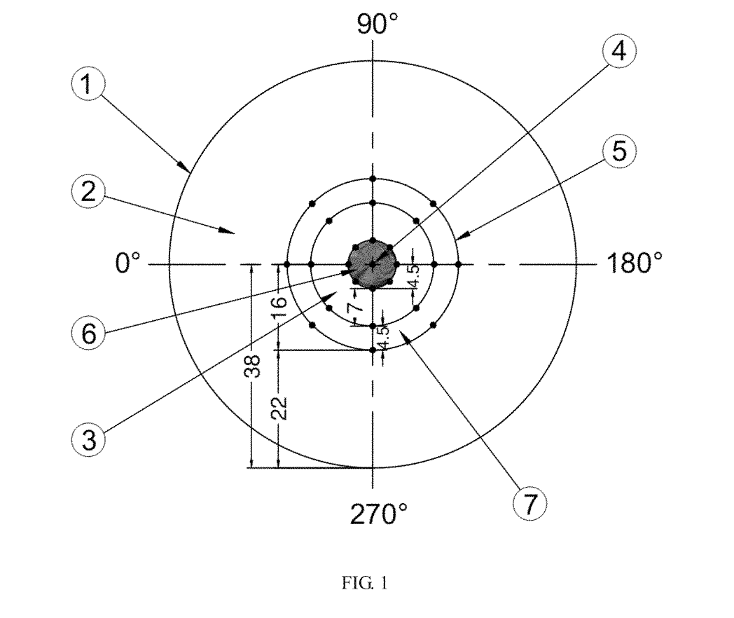

FIG. 2 is a side-view stereoscopic schematic drawing of the invention.

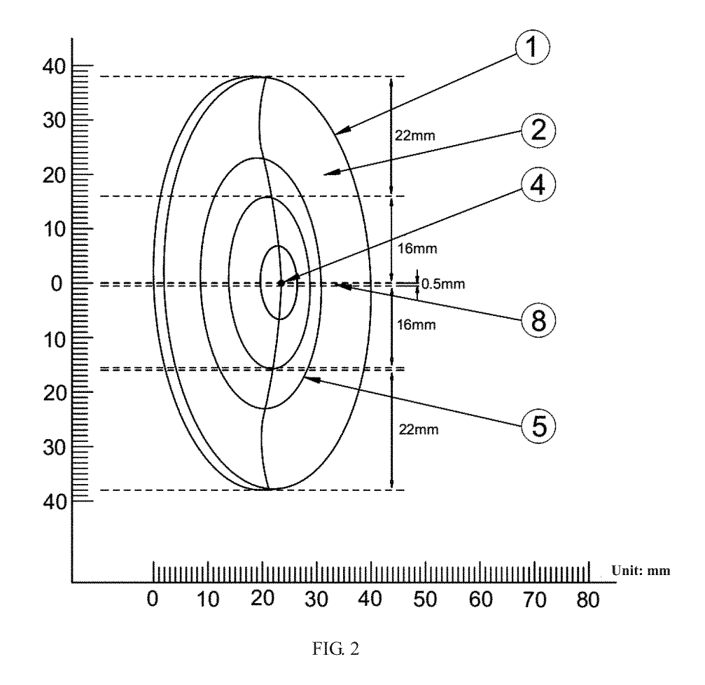

FIG. 3 is an overall structural schematic drawing of the invention.

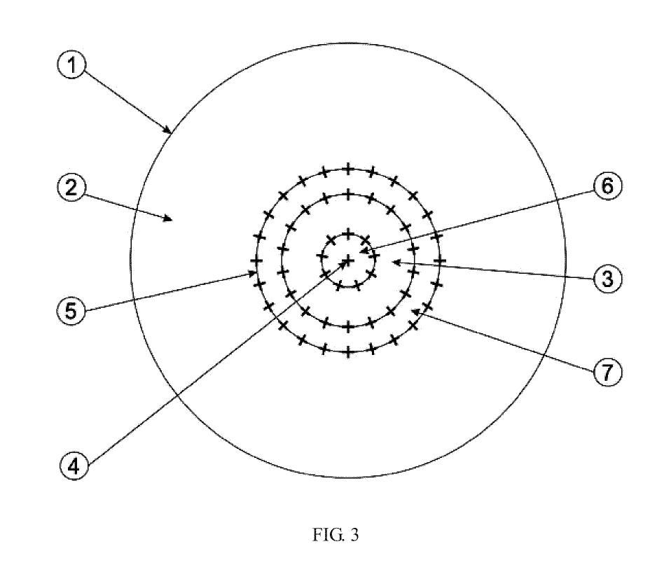

Reference number in drawings are as follows in sequence:

1 lens; 2 optical path guide zone; 3 mid-beam optical zone; 4 optical center and butterfly-shaped holographic focus ring; 5 free-focus lens; 6 high-beam zone and butterfly-shaped holographic focus ring; 7 low-beam zone; 8 progressive increase or decrease of 0.01 degree.

### DETAILED DESCRIPTION

The present invention will be further described in detail as below in conjunction with the drawings and the embodiments, in order to make the objective, the technical solution and the advantages of the present invention understand more clearly. It should be understood that the specific embodiments described here are merely used for explaining the present invention, rather than limiting the present invention.

With reference to 1 to 3, in an embodiment of the present invention, a holographic eyeglass lens comprises a lens body (1) whose central attention optical zone is a free-focus lens (5), and is provided with a butterfly-shaped holographic zoom ring in a direction from an optical center to the edge of the lens, wherein the radius of the butterfly-shaped holographic zoom ring is not smaller than 4.5 mm.

An optical path guide zone (2) is arranged at the periphery of the lens (1). Focusing will not be performed in the optical path guide zone (2) because just is plain ordinary resin adopted. The free-focus lens (5) serves to freely focus within a range of 16 mm from the optical center (4). When the degree of the specific optical center (4) is customized, the degree will progressively increase or decrease by 0.01 every a movement of 0.5 mm from the optical center (4) to the outer edge of the lens. A zone of moving 4.5 mm from the optical center towards the outer edge of the lens is defined as a high-beam focus zone (6). A zone of moving from 4.5 mm to 11.5 mm is defined as a mid-beam focus zone (3). Then, a zone of moving from 11.5 mm to 16 mm is defined as a low-beam focus zone (7). A zone from 16 mm to 38 mm, i.e., the outermost edge of the lens, is defined as the optical path guide zone (2).

Compared to the existing lens 1 that has only one focus point, the improved lens 1 realizes free focusing within a range of 16 mm from the optical center 4 in the free-focus lens 5, and the degree will progressively increase or decrease by 0.01 every a movement of 0.5 mm. The zone of moving 4.5 mm from the optical center towards the outer edge of the lens is defined as the high-beam focus zone (6). The zone of moving from 4.5 mm to 11.5 mm is defined as the mid-beam focus zone (3). Then, the zone of moving from 11.5 mm to 16 mm is defined as the low-beam locus zone (7). The zone from 16 mm to 38 mm, i.e., the outermost edge of the lens, is defined as the optical path guide zone (2).

The high-beam focus zone (6), the low-beam focus zone (7) and the mid-beam focus zone (3) are arranged within an attention optical zone from the optical center of the free-focus lens to 16 mm. The holographic eyeglass lens of the present invention brings distinct images and rich gradation in visual sense and has good effects of filtering ultraviolet rays, and other light waves of stray light and glare light harmful to sights of the eyes.

The holographic eyeglass lens comprises a lens body whose central attention optical zone is a free-focus lens, and is provided with a butterfly-shaped holographic zoom ring in a direction from an optical center to the edge of the lens, wherein the radius of the butterfly-shaped holographic zoom ring is not smaller than 4.5 mm. An optical path guide zone is arranged at the periphery of the lens. The free-focus lens serves to freely focus within a range of 16 mm from the optical center. A zone of moving 4.5 mm from the optical center towards the outer edge of the lens is defined as a high-beam focus zone. A zone of moving from 4.5 mm to 11.5 mm is defined as a mid-beam focus zone. Then, a zone of moving from 11.5 mm to 16 mm is defined as a low-beam focus zone. A zone from 16 mm to 38 mm, i.e., the outermost edge of the lens, is defined as the optical path guide zone. The holographic eyeglass lens of the present invention brings distinct images and rich gradation in visual sense and has good effects of filtering ultraviolet rays, and other light waves of stray light and glare light harmful to sights of the eyes.

The foregoing descriptions of the embodiments and their accompanying drawings of the invention are intended to illustrate and not to limit this invention. Various changes and modifications may be made to the embodiments without departing from the spirit of the invention. Therefore, the scope of the invention is to be limited only by the appended claims.

What is claimed is:

1. A holographic eyeglass lens, comprising a lens body (1) whose central attention optical zone is a free-focus lens (5), wherein an optical path guide zone (2) is arranged at the periphery of the lens (1); the free-focus lens (5) serves to freely focus within a range of 16 mm from an optical center; a zone of moving 4.5 mm from the optical center towards the outer edge of the lens is defined as a high-beam focus zone (6); a zone of moving from 4.5 mm to 11.5 mm is defined as a mid-beam focus zone (3); then, a zone of moving from 11.5 mm to 16 mm is defined as a low-beam focus zone (7); a zone from 16 mm to 38 mm, i.e., the outermost edge of the lens, is defined as the optical path guide zone (2).

2. The holographic eyeglass lens according to claim 1, wherein a butterfly-shaped holographic zoom ring is arranged at the high-beam focus zone in a direction from the optical center to the edge of the lens, wherein the radius of the butterfly-shaped holographic zoom ring is not smaller than 4.5 mm.

3. The holographic optical resin eyeglass lens according to claim 1, wherein the degree progressively decreases by 0.01 every a movement of 0.5 mm from the optical center (4) to the outer edge of the lens.
